(19) United States
(12) Patent Application Publication
(10) Pub. No.: US 2005/0173038 A1
(43) Pub. Date: Aug. 11, 2005

(54) Wheel rim consisting of two assembled structures

(75) Inventors: Georges Pirin, Chauriat (FR); Matthieu Bonnamour, Pont-Du-Chateau (FR); Michael Cogne, Mozac (FR)

Correspondence Address: BURNS DOANE SWECKER & MATHIS L L P, POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/031,035

(22) Filed: Jan. 10, 2005

Related U.S. Application Data
(63) Continuation of application No. PCT/EP03/07289, filed on Jul. 8, 2003.

(30) Foreign Application Priority Data
Jul. 8, 2002 (FR) 02/08644

(51) Int. Cl. B60C 15/02

(52) U.S. Cl. 152/381.5

(57) ABSTRACT

Wheel rim whose radially exterior geometry comprises an outer and an inner rim seat, a bearing surface formed essentially as a cylinder of revolution to receive a tire tread support ring, and whose radially interior geometry does not increase between the said mounting groove and the zone of connection to a wheel disc, which is made up by assembling a first, metallic structure constituting the radially interior geometry of the said rim and at least part of the radially exterior geometry of the said rim; and a second structure designed to constitute the said bearing surface radially on the outside, wherein the said second structure consists of an annular support element comprising at least one essentially axial opening and which comes in contact with the radially outer wall of the said first, metallic structure.

### TECHNICAL FIELD OF THE INVENTION

The object of the invention is a wheel, consisting of a disc and a rim for a tire, and able to form together with a support ring for the tire and its tread a rolling assembly that can be useful in the event of rolling when the inflation pressure is abnormally low compared with the normal utilization pressure known as the nominal service pressure, the actual pressure even being zero.

### BACKGROUND OF THE INVENTION

In its example embodiment of FIG. 6 the document WO 00/05083 describes a wheel rim whose radially exterior geometry comprises an outer and an inner rim seat, at least the outer rim seat having a generatrix whose axially outer end lies on a circle of diameter smaller than the diameter of the circle on which the axially inner end lies, the said outer rim seat being extended axially outwards by a projection or hump of small height and axially inwards by a flange, a bearing surface which is essentially a cylinder of revolution designed to receive a tread support ring which is positioned by sliding it on axially from the outside of the rim towards the inside, a mounting groove with outer and inner sidewalls, and whose radially interior geometry has a diameter which does not increase between the said mounting groove and the zone of connection to a wheel disc. This wheel rim is made by assembling a first, metallic structure constituting the radially interior geometry of the said rim and part of the said radially exterior geometry thereof; and a second structure designed to constitute the said bearing surface radially on the outside. The rim is such that the said second structure is a metallic collar formed as a cylinder of revolution, resting radially externally on the inner flange of the outer seat and on the outer sidewall of the mounting groove.

The wheel rim described by the said document has the advantage that, radially on the inside, it has no zone in which various matter accumulates during service. On the other hand, the metallic collar constituting the second structure has to be put in place around the first structure by fitting it from the axially outer side of the rim towards the axially inner side, and then welding. This greatly limits its geometry and its utility.

### SUMMARY OF THE INVENTION

In what follows, “axially outer side of the rim” is understood to mean the side E intended to be visible from outside the vehicle for which the rim is intended, and “axially inner side of the rim” means the side I intended to face towards the inside of the vehicle (see FIG. 1).

To obtain optimum lightness and overcome the above drawbacks, the wheel rim according to the invention, whose radially exterior geometry comprises an outer and an inner rim seat, at least the outer rim seat having a generatrix whose axially outer end lies on a circle of diameter smaller than the diameter of the circle on which the axially inner end lies, the said outer rim seat being extended axially outwards by a projection or hump of small height and axially inwards by a flange, a bearing surface which is essentially a cylinder of revolution designed to receive a tread support ring, and whose radially interior geometry has a diameter which does not increase between the said inner seat and the zone of connection to a wheel disc, is made by assembling:
a first, metallic structure constituting the radially interior geometry of the said rim and at least part of the radially exterior geometry of the said rim; and
second structure designed to constitute the said bearing surface radially on the outside.

The wheel rim is such that the second structure consists of a component which is cylindrical and open along one of its generatrices.

This component can easily be assembled around the first structure thanks to its slenderness and flexibility, without exceeding the elastic limit of the material of which it is made, and then rests against the radially outer wall of the first structure. Once the tread support ring has been positioned, the second structure is held perfectly in place and stable.

Preferably, the lips of the opening of this second structure in the form of a split ring are inclined obliquely relatively to the axial direction, to allow the second structure to be mounted in a spiral around the first structure.

A further object of the invention is a similar wheel rim wherein the said second structure consists of a circumferential assembly of at least two supporting elements which rest in contact with the radially outer wall of the said first, metallic structure.

Thus, the second structure is assembled directly around the first structure, giving it great freedom of design.

Preferably, the bearing surface constituted by the second structure comprises a radially outer circumferential groove designed to lock the support ring axially. This groove is particularly useful when the support ring is of limited axial width and when its axially outer part is not in contact with the flange of the outer seat. Such support-ring-adapted wheel rim assemblies are described in the document WO 01/08905 A1.

According to a preferred embodiment, the radially inner wall of the said first, metallic structure comprises, axially on the outside relative to the inner sidewall of the said mounting groove, a zone which is essentially a cylinder of revolution extending axially from the inner sidewall of the said mounting groove to the outer end of the said bearing surface.

Advantageously, the said second structure is then an annular structure of substantially constant thickness whose radially inner wall is essentially a cylinder of revolution and in which the whole of this radially inner wall is in contact with the radially outer wall of the first, metallic structure.

The second structure can then consist of a low-density material such as an unreinforced or only slightly reinforced thermoplastic, since the mechanical stresses it is subjected to in service during rolling on level ground are relatively low because of its very large contact area with the metallic structure.

The said second structure can also comprise at least two circumferential fins extending radially on the inside of the said bearing surface and serving as a support against the radially outer wall of the said first, metallic structure.

The material of the second structure is then preferably appreciably more rigid, namely a thermoplastic reinforced with glass fibers, or a thermosetting plastic, or even a metallic material such as a sheet of steel or aluminum.

The radially exterior geometry of the said first, metallic structure can comprise an outer sidewall of the said mounting groove, and the second structure will then be axially blocked on the inside by the said sidewall.

Alternatively, the axially inside end of the second structure can also constitute the outer sidewall of the said mounting groove.

In another embodiment, the said zone of the first structure formed essentially as a cylinder of revolution has, at the level of the said bearing surface, a smaller diameter with a step located at the level of the outer end of the mounting groove, designed to lock axially the axially inner end of the said second structure.

This geometry has the advantage of making the inside of the rim more rigid. As the diameter of the radially outer wall of the second structure is smaller, the second structure then has larger circumferential fins and it is therefore desirable to use a material of greater rigidity.

To lock the second structure axially on the first, a circumferential groove can be made in the wall of the first structure, which corresponds to that of the said cylindrical zone of revolution of the said second structure.

According to a third embodiment, between its mounting groove and the connection zone to the wheel disc the first, metallic structure has a wall whose axial diameter decreases continuously.

This geometry has the advantage of optimizing the mass and mechanical strength of the first, metallic structure. It is then necessary to design the second structure with circumferential contact fins appropriate in number and rigidity for the stresses to which it will be subjected in service when rolling on flat ground.

The said second structure can also be locked axially by blocking means which contact on the one hand the said inner sidewall of the flange of the said outer seat of the said first, metallic structure, and on the other hand an essentially circumferential fin of the said second structure.

These blocking means can advantageously be a screw-and-cone system.

The second structure can advantageously also comprise a zone essentially formed as a cylinder of revolution which extends the said bearing surface axially outwards and is designed to cooperate with the inner sidewall of the outer flange of the said first, metallic structure to support the said second structure and block it axially on the outside.

This embodiment has the advantage of extending the inner flange of the outer seat axially inwards, which reinforces the holding of the tire bead on the outer seat.

To facilitate the positioning of the support ring, it is then desirable for the outer wall of the complementary cylindrical revolution zone of the second structure to comprise a zone of smaller diameter than the outer diameter of the flange adjacent to the outer seat. This zone of smaller diameter facilitates the fitting of the ring onto the bearing surface by reducing the friction between the second structure and the inside wall of the ring.

Advantageously, the second structure can be fixed around the said first structure by complementary means chosen from among the group comprising clips, welds or adhesives.

A further object of the invention is a support element comprising means of assembly designed to make up a second structure by the assembly of at least two elements.

Preferably, the support elements are such that the said second structure is made up by assembling two or there support elements.

The means of assembly can be chosen from the group comprising clips, male/female systems, adhesives, welds or screws.

The material constituting the support elements can be chosen from the group comprising thermosetting resins, whether reinforced or not, thermoplastic resins, whether reinforced or not, and metallic materials such as steel or aluminum sheets.

### BRIEF DESCRIPTION OF THE DRAWINGS

Several embodiments of the invention are now described without limiting intent, with reference to the attached drawing which shows:

FIG. 1: Schematic radial cross-section of a first wheel rim according to the invention, comprising a very simple second structure

FIG. 2: A second variant of a wheel rim according to the invention

FIG. 3: A third variant of a wheel rim according to the invention

FIG. 4: Wheel rim similar to that of FIG. 1, with a second structure which includes a connection with the inner flange of the outer seat

FIG. 5: Fifth variant of the wheel according to the invention, with a second structure made of aluminum sheet

FIG. 6: Variant of a wheel rim according to the invention, with a first, metallic structure made of steel sheet

FIG. 7: Radial section showing an enlargement of FIG. 1 including the assembly means of the second structure

FIG. 8: The wheel rim of FIG. 7 shown in circumferential section, before assembly around the first structure

FIG. 9: Similar to FIG. 8, after assembly

FIG. 10: Wheel rim with a screw cone system for locking the second structure on the first

FIG. 11: Sectional view of a wheel rim with a second structure in the form of a split ring

FIG. 12: The wheel rim of FIG. 11 after mounting a tread support ring, and

FIG. 13: Example of means of assembly for a second structure in the form of a split ring

### DETAILED DESCRIPTION IF THE PREFERED EMBODIMENTS

FIG. 1 shows a first example of a wheel rim 1 according to the invention. In the example shown, this rim is made of a cast aluminum alloy. The wheel rim comprises two seats, one outer 2 and one inner 2′ seat. The outer seat 2 is extended on the outside of the rim by a projection or hump of small height 3, and on the inside by a flange 4. The inner seat 2′ is extended on the inside by a hump 3′ and on the outside by a flange 4′. The two seats are inclined inversely from those of usual wheel rims. The rim 1 also comprises a mounting groove 5 with an outer 5″ and an inner 5′ sidewall, and a bearing surface 6 designed to receive a tread support ring (not shown) which is positioned on the bearing surface 6 by sliding it on from the outside E towards the inside I of the rim. It should be noted that the diameter of the bearing surface 6 must therefore be larger than or equal to that of the flange 4 for this fitting operation to be possible. The bearing surface comprises a circumferential groove 6″ designed to cooperate with a ridge of appropriate size formed on the inside wall of the support ring to lock the latter axially once it has been positioned. A supplementary locking projection 6′″ is also located at the inside end of the surface 6. The wheel rim also has a lightening groove 7 with an outer 7′ and an inner 7″ sidewall designed to reduce the weight of the wheel. This groove 7 extends circumferentially between the flange 4 and the bearing surface 6. On the radially inner side of the rim there is, in particular, the connection zone 8 to a wheel disc (not shown). Such wheel rims are described in particular in the document WO 00/05083 cited earlier.

The wheel rim 1 is made up by assembling a first, metallic structure 10 and a second structure 20. The first structure 10 includes the inner 2′ and outer 2 seats, the humps 3 and 3′, the flanges 4 and 4′, the lightening groove, part of the mounting groove 5 and all the radially interior geometry of the wheel rim 1. The second structure 20 comprises the bearing surface 6 with the locking projection 6′″, the groove 6″ and the zone 6′ with diameter larger than the surface 6, as well as the outer sidewall 5″ of the mounting groove 5.

Note that the first and second structures cooperate at the outer end of the surface 6 to lock this second structure axially by means of a lip 21 which comes in contact with an essentially vertical sidewall 15 of the first structure. The axial locking is completed by a circumferential groove 14 formed opposite the groove 6″ in the first structure. The zone 12 of the first structure located between the mounting groove 5 and the inner wall 7′ of the lightening groove, i.e. between the mounting groove 5 and the whole of the zone radially opposite the bearing surface 6, is essentially a cylinder of revolution. As a result the thickness of the second structure is small and it can consist of a ring assembled from support elements made of a composite material of low rigidity, such as a thermoplastic with little or no reinforcement. Since the two surfaces, the radially outer surface 13 of the first structure and the radially inner surface 22 of the second structure, are in contact all over, the stresses to which this second structure is subjected in service when rolling on flat ground are of small intensity.

The metallic structure 10 can be made of various materials and by various technologies. The materials best adapted to this application for industrial mass-production are aluminum and steel. The profiles of this metallic structure are simpler to produce than those of the wheels proposed in the application WO 01/08905. In particular, the lateral abutment of the support and the circumferential groove serving to lock the support (clip) can be integrated in the second structure. Moreover, the radially inner profile of the first structure needs little or no machining and avoids any retention zone. Thus, the production of this first, metallic structure is very similar to that of a wheel with a standard profile. Consequently the cost of the first structure is likely to be lower than that of a wheel with geometry similar to that presented in the document WO 01/08905.

The support elements of the second structure can be made from any sorts of materials. Nevertheless, the support element is advantageously made from thermoplastic or thermosetting materials, whether reinforced or not, or even from an aluminum alloy. In effect, these materials offer a good compromise between strength, density, industrial feasibility and cost. Depending on the material chosen, its thermo-mechanical properties and process constraints, adaptations of shape may be needed.

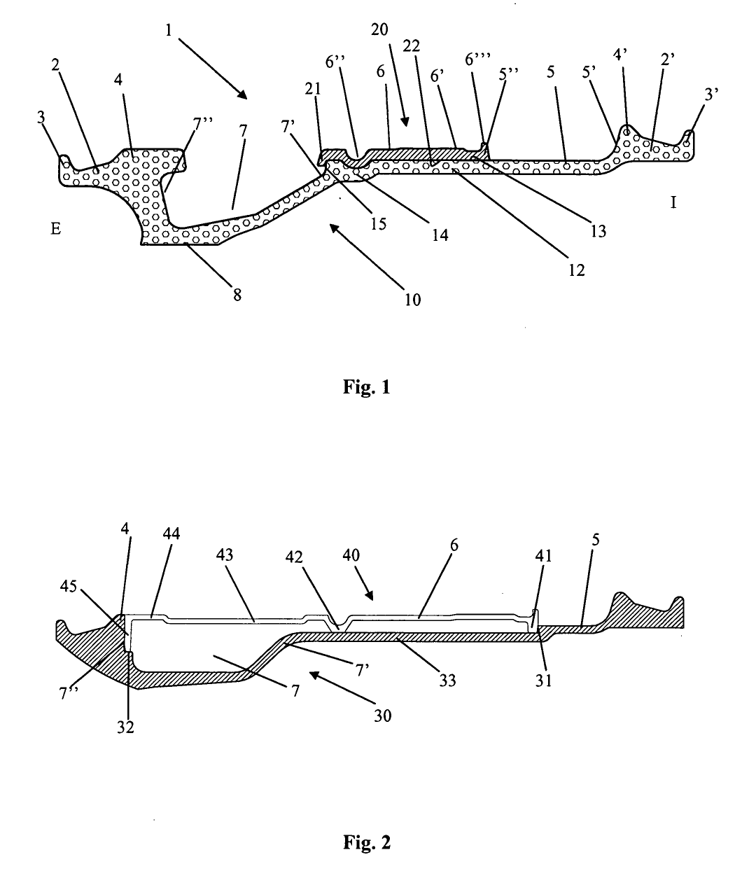

FIG. 2 shows a second assembly of a first structure 30 and a second structure 40 according to the invention.

The first structure 30 differs from the previous one 10 in having a step 31 at the outer end of the mounting groove 5. This step implies that the diameter of the cylindrical revolution zone 33 arranged opposite the bearing surface 6 is smaller than that of the mounting groove 5. Consequently, on the radially outer surface of the first structure at the level of the step 31 there is an essentially vertical sidewall which serves as an axial blocking abutment for the second structure 40. Note also that the connection between the inner sidewall 7′ of the lightening groove 7 and the cylindrical zone of revolution 12 has no vertical sidewall 15.

The step 31 results in an increase of the distance between the radially outer wall 13 of the first structure and the bearing surface 6. Consequently, the second structure has two circumferential fins 41 and 42 extending radially between the bearing surface 6 and the wall 13, which serve to support the second structure 40. The fin 42 extends from the circumferential groove 6″. The fin 41 is in axial contact against the vertical wall produced by the step 31. The second structure 40 also has an extension formed essentially as a cylinder of revolution 43 and 44, which extends axially outwards from the bearing surface 6 to the flange 4. The part 44 of this extension has a diameter essentially identical to that of the flange 4 so as to participate in the function of the flange 4 to prevent jamming of the tire bead. The outer sidewall 7″ of the lightening groove 7 cooperates with a fin 45 at the outer end of the extension 43 to fix the second structure axially thanks to an axial shoulder 32. The axially inner part of the extension 43 preferably has a smaller diameter, to facilitate the fitting of the support ring over the extension 43 by reducing the friction forces during fitting.

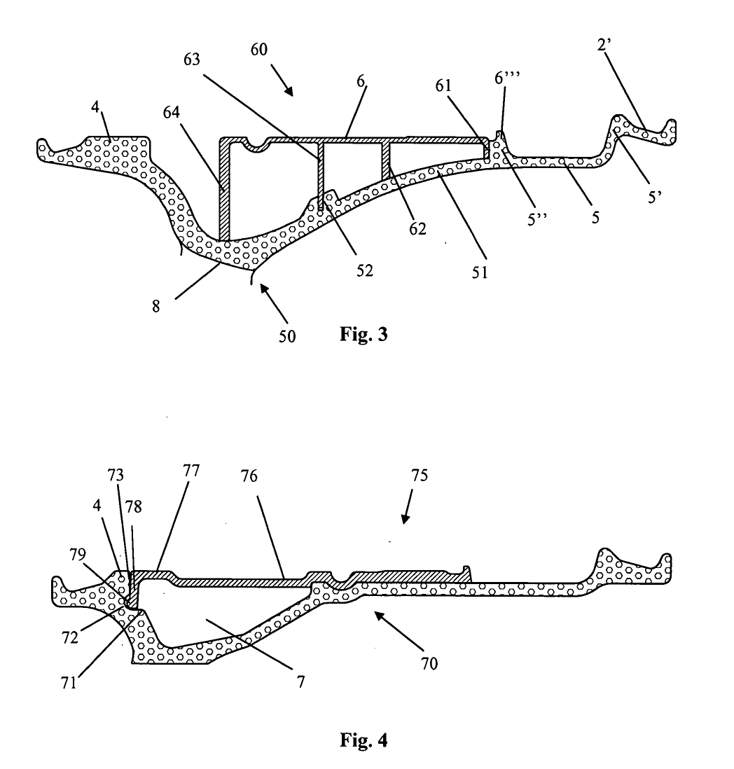

FIG. 3 shows a third assembly of a first structure 50 and a second structure 60 according to the invention.

The first structure 50 differs from the previous ones in that the diameter of the zone 51 between the inner seat 2′, and more precisely the outer end of this inner seat, and the connection zone to the wheel disc 8, decreases continuously. This facilitates the production of the said first structure by making it easier to extract from the mould and by reducing the number of machining sequences. Note also that the outer sidewall 5″ of the mounting groove 5 is part of this first structure and that this sidewall 5″ comprises the projection 6′″ which blocks the tread support ring axially.

The second structure 60 comprises an essentially cylindrical bearing surface 6 in contact with the radially outer wall of the zone 51 via four circumferential fins 61, 62, 63, 64 whose thickness is appropriate for the stresses encountered in service. The fin 61 rests against the sidewall 5″ of the first structure. To complete the locking of the second structure 60 around the first structure 50, the fin 63 is fitted into a locking groove 52 formed in the outer wall of the zone 51 of the first structure. Bearing in mind the height of the circumferential fins of the second structure, the latter is preferably made from a material of high rigidity, for example a rigid thermosetting material or a thermoplastic reinforced with glass fibers.

FIG. 4 shows a fourth assembly of a first, metallic structure 70 and a second structure 75. The first, metallic structure 70 is very similar to the metallic structure 10 of FIG. 1. It differs only in that the outer side of the lightening groove 7 comprises a radial sidewall 73 followed by a groove 72 and an axial shoulder 71 to serve as a support and abutment for an outer fin 78 of an extension 76-77 of the second structure 75 of the bearing surface 6 as far as the flange 4. This extension is similar to the one 43-44 shown in FIG. 2. The extension ends axially on the outside in a fin 78 which makes contact with the axially shoulder 71. The fin 78 also comprises a rib 79 adapted to the groove 72 so that, when the second structure is fitted around the first, the said rib 79 will clip into the groove 72 and so reinforce the holding of the second structure into the first.

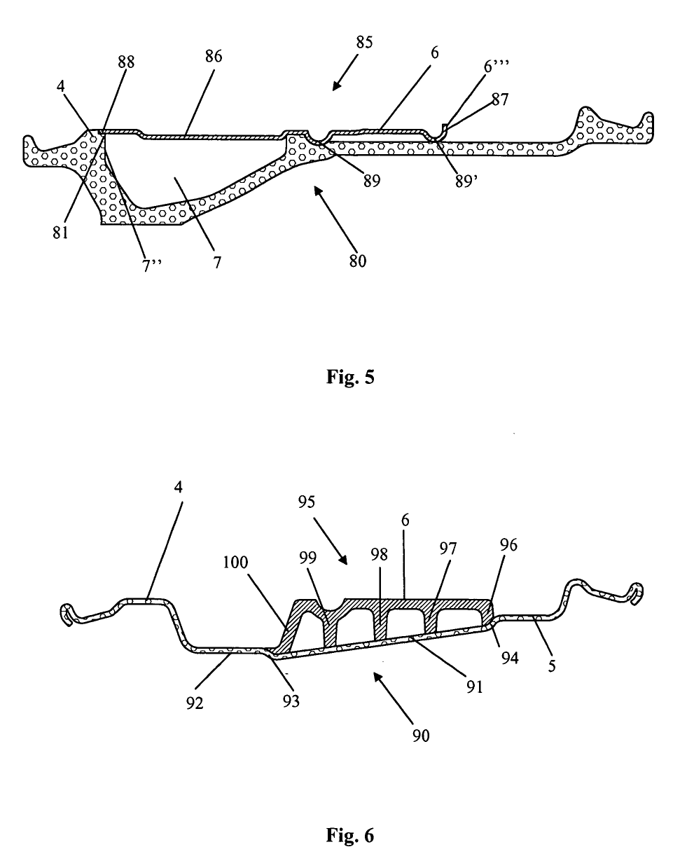

FIG. 5 shows a fifth example of a wheel rim according to the invention, comprising a first, metallic structure 80 and a second structure 85. The first, metallic structure 80 is again very similar to the metallic structure 10 of FIG. 1. It differs only in that the outer sidewall 7″ of the lightening groove 7 comprises an axial shoulder 81 designed to support the outer end 88 of the outer extension 86 of the second structure 85. The radial thickness of the shoulder is such that the second structure extends the flange 4 with the same diameter on the inside. The second structure 85 is in this case made of metallic sheet, namely steel or aluminum. The outer end 88 makes contact against the shoulder 81 and the axially inner end 87 is curved in a circular arc to constitute the outer sidewall 5″ of the mounting groove 5 and the axial blocking projection 6′″ of the support ring. Two fins 89 and 89′ enable the outer diameter of the second structure 85 to be adapted to the diameter required for the bearing surface 6. The fin 89 is in the form of a rib that cooperates with a rib formed in the first structure to complete the axial locking of the second structure.

The support elements of the second structure are advantageously made of aluminum sheet, to obtain the best compromise between weight and industrial feasibility.

FIG. 6 shows a sixth example of a wheel rim according to the invention, comprising a first, metallic structure 90 and a second structure 95. The first, metallic structure 90 consists of a metallic sheet, namely steel or aluminum, whose thickness is substantially constant. A wheel disc (not shown) has to be welded to the radially inner wall of the zone 92, and so corresponds to the bottom of the lightening groove 7. Between the mounting groove 5 and this connection zone 92 to a wheel disc, there are axially and in succession a first step 94, a zone 91 in which the diameter under the bearing surface 6 decreases essentially regularly, and a step 93 directed outwards. The purpose of the two circumferential steps 94 and 93 is to block the second structure 95 axially once it has been put in place around the first. The second structure 95 comprises a bearing surface 6 and five support fins against the zone 91: 96, 97, 98, 99 and 100. The radially inner ends of the fins 96 and 100 are respectively adapted to fit the shape of the outer walls of the steps 94 and 93 and to block the second structure axially.

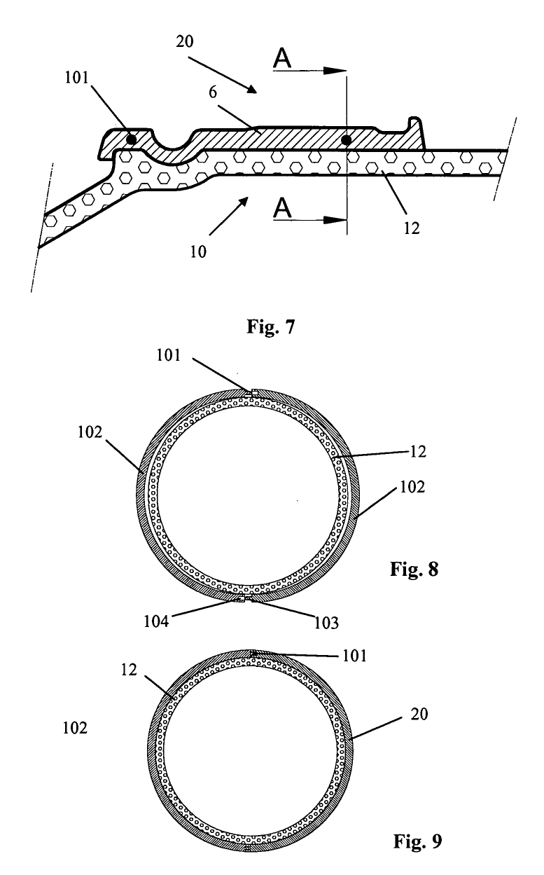

FIG. 7 shows an enlarged view of the wheel rim of FIG. 1 to illustrate an example of means 101 for assembling the support elements 102 of the second structure 20 on the first structure 10.

FIGS. 8 and 9 are circumferential sections AA of the wheel rim as indicated in FIG. 7. FIG. 8 shows two support elements 102 before their assembly around the position 12 of the first structure 10. Each support element comprises assembly means 101 in this case consisting of a male part 103 and a female part 104 positioned at the two ends of each element. In FIG. 9 the second structure 20 consists of the assembly of the two support elements 102. The male 103 and female 104 parts are fitted into one another. Note that means of assembly such as these are sufficient because of the low tensile stresses occurring during service due to the presence of a support ring all round.

Of course, the support elements, which are in this case semi-circumferential, can also be sized for one-third of the circumference. Beyond that, it is found that the assembly takes longer to put together.

As already indicated by the previous examples, the second structure can be positioned on the first by various means such as clipping, the presence of blocking abutments, adhesive bonding, etc.

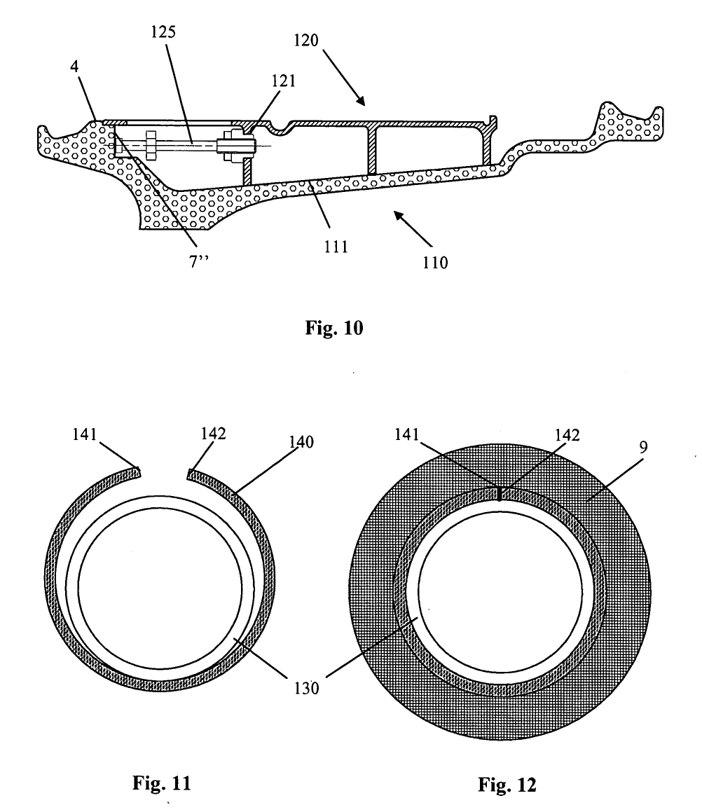

FIG. 10 illustrates a second principle for fixing a second structure 120 around a metallic structure 110. In the figure, the method of fixing the second structure to the metallic structure utilizes the principle of conical tightening. The various support elements constituting the second structure 120 are previously assembled with one another around the first, metallic structure so as to form a monoblock assembly. The second structure can then be pushed by means of one or more screws 125 onto the cone formed by the surface 111. The screw(s) 125 rest(s) against the outer sidewall 7″ of the lightening groove and push(es) the fin 121 of the second structure 120. Appropriate devices 125 are well known to those with knowledge of the field. Thus, when a certain torque is applied to the screw(s) 125, the second structure is locked onto the first, metallic structure. This system also enables the various plays related to different machining and/or manufacturing tolerances of the metallic structure and of the support elements constituting the second structure, to be taken up.

FIGS. 11, 12 and 13 show circumferential sections of an example of another embodiment of a second structure according to the invention, in which the said second structure is cylindrical and open along one of its generatrices. The second structure is thus in the form of an open ring. The circumferential sections shown are sections AA as in FIG. 7.

This second structure can be arranged easily around the first structure thanks to its slender form and flexibility. FIG. 11 shows a first structure 130 with a second structure 140 in the form of an open ring positioned around it. The two lips 141 and 142 of the opening of the ring 140 are far apart to allow it to be positioned.

FIG. 12 shows the same wheel rim after a tread support ring 9 has been fitted all around the second structure 140. It can be seen that the lips 141 and 142 are now pressed together by the hoop action of the ring 9.

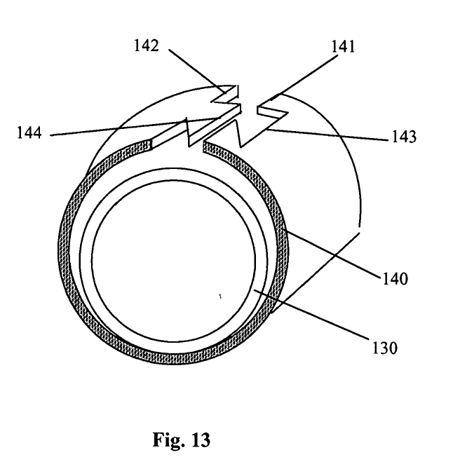

FIG. 13 shows a schematic example of means for assembling the lips 141 and 142 of the second structure 140 to enable it the more easily to be held in place on the first structure 130. In this case these assembly means are in the form of a mortice and tenon 142-143 to allow the second structure to be clipped into position.

The various wheel rims composed of a first and second structure as shown, have a bearing surface that can easily be adapted to all the axial widths considered for tread support rings. Examples of such appropriate support rings are described in the document WO 00/08905.

The embodiments described above have only been provided as non-limiting examples and can be modified in any desired way without thereby exceeding the scope of the invention within the scope of the appended claims and their equivalents.

1. Wheel rim whose radially exterior geometry comprises an outer rim seat and an inner rim seat, at least the outer rim seat having a generatrix whose axially outer end lies on a circle of diameter smaller than the diameter of the circle on which the axially inner end lies, the said outer rim seat being extended axially outwards by a projection or hump of small height, and axially inwards by a flange, a bearing surface essentially formed as a cylinder of revolution designed to receive a tire tread support ring, and whose radially interior geometry has a diameter which does not increase between the said inner seat and the zone of connection to a wheel disc, which is made up by assembling:
a first, metallic structure which constitutes the radially interior geometry of the said nm and at least part of the radially exterior geometry of the said rim; and
a second structure designed to constitute the said bearing surface radially on the outside,
wherein the said second structure consists of a cylindrical component open along one of its generatrices.

2. Wheel rim according to claim 1, in which the lips of the opening of the said second structure are inclined obliquely relative to the axial direction.

3. Wheel rim according to claim 1, wherein the said second structure consists of the circumferential assembly of at least two support elements which make contact with the radially outer wall of the said first metallic structure.

4. Wheel rim according to claim 1, in which the said rim also comprises a mounting groove with an inner sidewall and an outer sidewall, and the radially inner wall of the said first, metallic structure comprises, axially on the outside relative to the outer sidewall of the said mounting groove, a zone formed essentially as a cylinder of revolution, which extends axially from the outer sidewall of the said mounting groove to the outer end of the said bearing surface.

5. Wheel rim according to claim 4, in which the second structure is an annular structure of substantially constant thickness whose radially inner wall is essentially formed as a cylinder of revolution and in which the whole of this radially inner wall on the opposite side to the bearing surface is in contact with the radially outer wall of the first, metallic structure.

6. Wheel rim according to claim 1, in which the first metallic structure has a wall between the said inner seat and the disc connection zone, whose axial diameter decreases continuously.

7. Wheel rim according to claim 1, in which the second structure comprises at least two circumferential fins which extend radially inwards from the said bearing surface and serve to support it against the radially outer wall of the said first, metallic structure.

8. Wheel rim according to claim 1, in which the axially inner end of the said second structure constitutes the outer sidewall of the said mounting groove.

9. Wheel rim according to claim 8, in which the said first structure has, adjacent outward of the mounting groove, a smaller diameter with a step located at the level of the outer end of the mounting groove, which is designed to block the axially inner end of the second structure axially on the inside.

10. Wheel rim according to claim 1, in which the said second structure also comprises a zone formed essentially as a cylinder of revolution which extends the said bearing surface axially outwards and is designed to cooperate with the inner sidewall of the flange of the outer seat of the said first, metallic structure to support the said second structure and lock it axially on the outside.

11. Wheel rim according to claim 10, in which the said flange of the said outer seat has an inner sidewall, and the said second structure is axially locked by blocking means in contact on the one hand against the said inner sidewall of the flange of the said outer seat of the said first metallic structure and on the other hand against an essentially circumferential fin of the said second structure.

12. Wheel rim according to claim 11, in which the said blocking means consist of a screw-and-cone system.

13. Wheel rim according to claim 10, in which the outer wall of the complementary cylinder of revolution zone of the second structure comprises a zone of diameter smaller than the outer diameter of the flange adjacent to the outer seat.

14. Wheel rim according to claim 1, in which the said second structure is fixed around the said first structure by means chosen from the group comprising clips, welds, adhesives and mechanical anchoring means.

15. Wheel rim according to claim 1, in which the said bearing surface comprises a circumferential groove designed to lock the said support ring axially.

16. Wheel rim according to claim 15, in which the said first metallic structure comprises a circumferential groove corresponding to that of the said cylindrical revolution zone of the said second structure designed to lock the said second structure axially.

17. Support element comprising assembly means designed to constitute a second structure according to claim 1, by assembly of at least two lips of the said support element.

18. Support element according to claim 17, in which the said assembly means are chosen from the group comprising clips, male-female systems, adhesives, welds or screws and nuts.

19. Support element according to claim 17, in which the material constituting the said support element is chosen from the group comprising thermosetting resins, whether reinforced or not, thermoplastic resins, whether reinforced or not, and metallic materials.

20. Support element comprising assembly means designed to constitute a second structure according to claim 3, in which the said second structure is formed by the assembly of two or three support elements.

21. Support element according to claim 20, in which the said assembly means are chosen from the group comprising clips, male-female systems, adhesives, welds or screws and nuts.

22. Support element according to claim 20, in which the material constituting the said support element is chosen from the group comprising thermosetting resins, whether reinforced or not, thermoplastic resins, whether reinforced or not, and metallic materials.
